(19) United States
(12) Patent Application Publication
(10) Pub. No.: US 2006/0230885 A1
(43) Pub. Date: Oct. 19, 2006

(54) Compound hand tool

(76) Inventor: Philip Olson, White Bear Lake, MN (US)

Correspondence Address: SHERRILL LAW OFFICES, 4756 BANNING AVE, SUITE 212, WHITE BEAR LAKE, MN, 55110-3205, US

(21) Appl. No.: 11/107,129

(22) Filed: Apr. 15, 2005

(51) Int. Cl. B25B 23/16; B25B 13/58; B25G 1/00

(52) U.S. Cl. 81/177.85; 81/177.2; 81/180.1

(57) ABSTRACT

A compound tool comprising various combinations of one or more handles one or more attachments for in-line releasable engagement of the handle and/or an adaptor for in-line releasable engagement of the handle and one or more bits for in-line releasable engagment of the adaptor.

### BACKGROUND

Compound hand tools are commonly available and include such omnipresent hand tool kits as socket wrench sets, screwdriver and screwdriver bit sets, jigsaw and jigsaw blade sets, drill and drill bit sets, etc.

Compound tools are in widespread use as they provide a significant cost savings over the option of purchasing individualized tools, and require significantly less storage space.

While numerous compound tools are currently available, a continuing need exists for additional compound tools capable of providing further reductions in cost and storage space.

### SUMMARY OF INVENTION

A first aspect of the invention is a compound tool comprising a longitudinally elongated handle and at least two operably different attachments. The handle has a first longitudinal end, a second longitudinal end, and a first portion of a coupling system proximate the second longitudinal end of the handle. Each attachment includes a longitudinally extending shank and a head longitudinally extending from the second longitudinal end of the shank. The shank has a second portion of the coupling system proximate the first longitudinal end operative for releasably engaging the first portion of the coupling system. The head of at least two of the attachments are operably different from each other.

A second aspect of the invention is a compound tool comprising a longitudinally elongated handle, at least two operatively different bits and an adaptor. The handle has a first longitudinal end, a second longitudinal end, and a first portion of a first coupling system proximate the second longitudinal end of the handle. Each bit has a first longitudinal end with an operable tip proximate the first longitudinal end of the bit, and a second longitudinal end with a first portion of a second coupling system proximate the second longitudinal end of the bit. The adaptor has a first longitudinal end with a second portion of the first coupling system operative for releasably engaging the first portion of the first coupling system, and a second longitudinal end with a second portion of the second coupling system proximate the second longitudinal end of the adaptor operative for releasably engaging the first portion of the second coupling system.

A third aspect of the invention is a compound tool comprising a plurality of longitudinally elongated handles, and at least one cooperating element. Each handle has a first longitudinal end, a second longitudinal end, a first portion of a first coupling system proximate the first longitudinal end of the handle, and a second portion of the first coupling system proximate the second longitudinal end of the handle operative for releasably engaging the first portion of the first coupling system. The handles are capable of forming a longitudinally extended lever when the first portion of the first coupling system on one handle engages the second portion of the first coupling system on another handle. At least one of the cooperating elements is an attachment or a combination of a bit and an adaptor. The attachment includes a longitudinally extending shank and a head longitudinally extending from the second longitudinal end of the shank. The shank has a second portion of the first coupling system proximate the first longitudinal end of the shank. The first coupling system is operative for releasably attaching the handle and shank in a longitudinally aligned configuration. The combination includes a bit and an adaptor. The bit has an operable tip proximate the first longitudinal end of the bit, and a first portion of a second coupling system proximate the second longitudinal end of the bit. The adaptor has a second portion of the first coupling system proximate the first longitudinal end of the adaptor operative for releasably engaging the first portion of the first coupling system, and a second portion of the second coupling system proximate the second longitudinal end of the adaptor operative for releasably engaging the first portion of the second coupling system. The handle and adaptor are longitudinally aligned when the first portion of the first coupling system on the handle and the second portion of the first coupling system on the adaptor are engaged. Similarly, the adaptor and bit are longitudinally aligned when the first and second portions of the second coupling system are engaged.

### BRIEF DESCRIPTION OF THE DRAWINGS

FIG. 1 is a front view of one embodiment of the handle portion of the invention depicting an attachment operably connected to the handle in phantom.

FIG. 2 is a side view of the invention shown in FIG. 1 absent the attachment.

FIG. 3 is a front view of one embodiment of the attachment portion of the invention with a socket wrench head.

FIG. 4 is a front view of one embodiment of the attachment portion of the invention with an open end wrench head.

FIG. 5 is a front view of one embodiment of the attachment portion of the invention with an adjustable end wrench head.

FIG. 6 is a front view of one embodiment of the attachment portion of the invention with a box end wrench head.

FIG. 7 is a front view of one embodiment of an adapter portion of the invention fitted with a straight edge screwdriver bit.

FIG. 8 is a front view of the adapter shown in FIG. 7 fitted with a Philips screwdriver bit.

FIG. 9 is a front view of the adapter shown in FIG. 7 fitted with an Allen wrench bit.

FIG. 10 is a front view of one embodiment of a socket.

FIG. 11 is a front view of a second embodiment of the attachment portion of the invention with a socket wrench head.

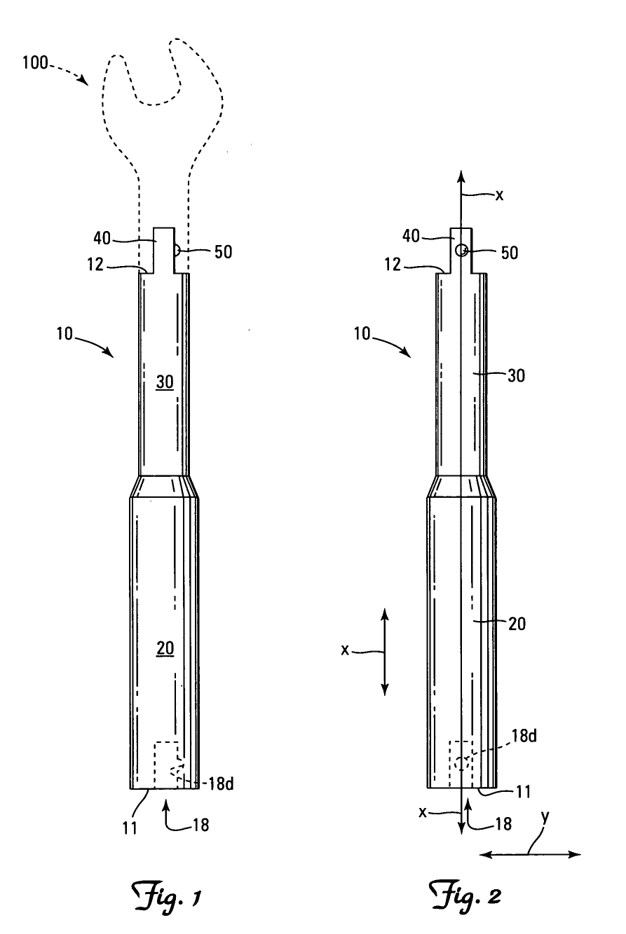

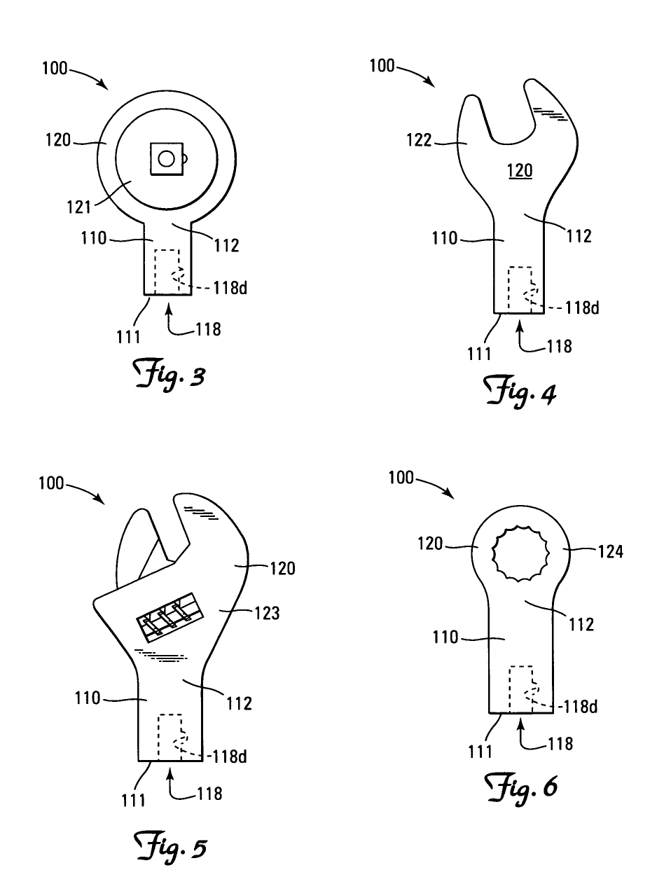

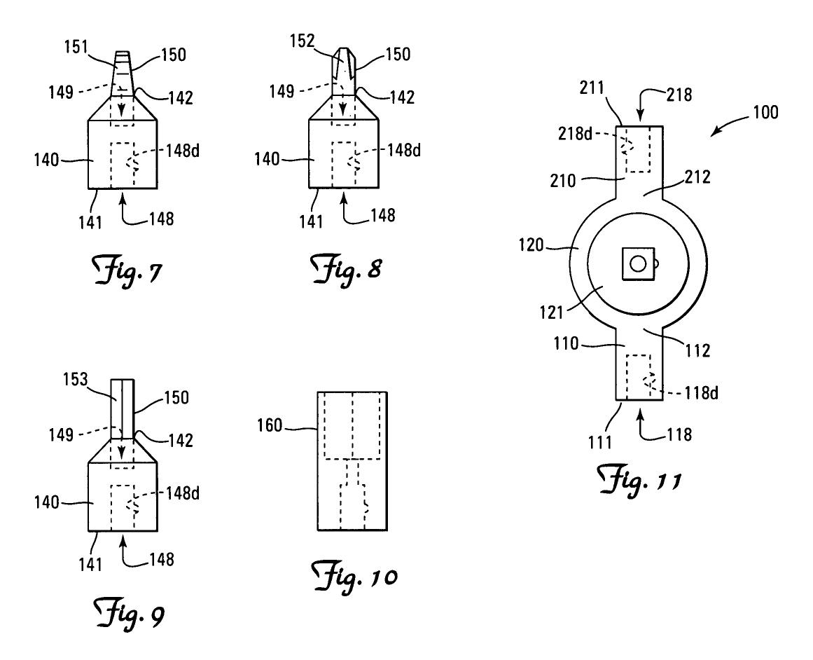

### DETAILED DESCRIPTION OF THE INVENTION INCLUDING A BEST MODE

Nomenclature

10 Handle
11 First Longitudinal End of Handle
12 Second Longitudinal End of Handle
18 Longitudinal Receiving Cavity In First Longitudinal End of Handle
18d Dimple in Sidewall of Receiving Cavity
20 Grip
30 Shaft
40 Post
50 Detent
100 Attachment
110 Shank Portion of Attachment
111 First Longitudinal End of Shank
112 Second Longitudinal End of Shank
118 Longitudinal Receiving Cavity In First Longitudinal End of Shank
118d Dimple in Sidewall of Receiving Cavity
120 Head Portion of Attachment
121 Socket Wrench Head
122 Open End Wrench Head
123 Adjustable End Wrench Head
124 Box End Wrench Head
140 Adaptor
141 First Longitudinal End of Adaptor
142 Second Longitudinal End of Adaptor
148 First Longitudinal Receiving Cavity In First Longitudinal End of Adaptor
148d Dimple in Sidewall of Receiving Cavity
149 Second Longitudinal Receiving Cavity In Second Longitudinal End of Adaptor
150 Bit
151 Straight Edge Screwdriver Bit
152 Philips Screwdriver Bit
153 Allen Wrench Bit
160 Socket
210 Secondary Shank Portion of Attachment
211 First Longitudinal End of Secondary Shank
212 Second Longitudinal End of Secondary Shank
218 Longitudinal Receiving Cavity In First Longitudinal End of Secondary Shank
218d Dimple in Sidewall of Receiving Cavity
x Longitudinal Axis
y Transverse Direction
   Definitions

As utilized herein, including the claims, the term “set” means a plurality of similarly configured and arranged items of varying size. For example, a set of metric sockets could include one each of a 3 mm, 4 mm, 5 mm, 6 mm, 7 mm, 8 mm, 9 mm, 10 mm, 12 mm, 13 mm, 14 mm and 15 mm socket, and a set of box end wrench could include one each of a ¼^{th inch,} 5/16^{th} inch, 11/32^{nd} inch, ⅜^{th} inch, 7/16^{th} inch, ½ inch, 9/16^{th} inch, ⅝^{th} inch, 11/16^{th} inch and ¾^{th} inch box end wrench.

Construction

The invention is a compound tool comprising various combinations of one or more handles 10, one or more attachments 100 capable of in-line releasable engagement with a handle 10 and/or an adaptor 140 capable of in-line releasable engagement with a handle 10 at one end and in-line releasable engagement with a bit 150 at the other end.

The handle 10 is preferably constructed from steel and has a first longitudinal end 11, a second longitudinal end 12, and a first portion of a first coupling system, such as post 40, longitudinally x extending from the second longitudinal end 12 of the handle 10. The handle 10 preferably includes a grip 20 and a shaft 30. The grip 20 forms the first longitudinal end 11 of the handle 10 and can be knurled or covered with a pliant material such as rubber for permitting a user to attain a secure grip on the handle 10. The shaft 30 longitudinally x projecting from the grip portion 20 and forms the second longitudinal end 12 of the handle 10.

The handle 10 preferably includes a second portion of the first coupling system, such as a receiving cavity 18, proximate the first longitudinal end 11 of the handle 10 operative for releasably engaging the first portion of the first coupling system, (e.g., post 40). By incorporating a second portion of the first coupling system proximate the first longitudinal end 11 of the handle 10, a longitudinally x extended lever comprising multiple handles 10 may be formed by connecting the first portion of the first coupling system on one handle 10 and the second portion of the first coupling system on another handle 10.

The post 40 has at least three longitudinally x extending parallel edges (unnumbered) (i.e., the number of edges when the post 40 has a triangular cross-section) and preferably four longitudinally x extending parallel edges (i.e., the number of edges when the post 40 has a square cross-section). Such longitudinally x extending parallel edges prevents handle 10 from rotating about the longitudinal axis x defined by the handle 10 relative to any attachment 100 or adaptor 140 mounted onto the post 40.

The post 40 preferably includes a detent 50, such as a spring-biased ball bearing as is commonly employed on socket wrenches, extending transversely y from the post 40 for cooperatively engaging a dimple 18d within a receiving cavity 18 in another handle 10, or a dimple 118d within a receiving cavity 118 on an attachment 100, or a dimple 148d within a receiving cavity 148 on an adaptor 140 and thereby providing modest resistance against longitudinal x detachment of the second handle 10, attachment 100 or adaptor 140 from the post 40.

The attachments 100 each have a longitudinally x extending shank 110 and a head 120. The shank 110 has a second portion of the first coupling system, such as a longitudinally x extending receiving cavity 118, in the first longitudinal end 111 of the shank 110 configured and arranged for releasably engaging the first portion of the first coupling system, such as post 40. The head 120 longitudinally x extends from the second longitudinal end 112 of the shank 110.

The head 120 may be selected from any number of hand tool heads commonly attached to a handle 10 for use, including a socket wrench head 121, an open end wrench head 122, an adjustable end wrench head 123, a box end wrench head 124, a gear driven box end wrench head (not shown), a pipe wrench head (not shown), etc.

The adaptor 140 has a second portion of the first coupling system, such as a first longitudinally x extending receiving cavity 148, proximate the first longitudinal end 141 of the adaptor 140 operative for releasably engaging the first portion of the first coupling system, such as post 40. The adaptor 140 also has a second portion of a second coupling system, such as a second longitudinally x extending receiving cavity 149, proximate the second longitudinal end 142 of the adaptor 140 operative for releasably engaging a first portion of the second coupling system, such as the shank (unnumbered) of a bit 150.

The bits 150 may be selected from any number of hand tool bits commonly attached to a handle 10 for use, including a straight edge screwdriver bit 151, a Philips screwdriver bit 152, an Allen wrench bit 153, a torx bit (not shown), a small socket (not shown), etc.

In a first preferred embodiment, the compound tool is provided as a tool kit with at least (i) one handle 10, preferably at least two handles 10 with one handle 10 sized for light duty and the other sized for heavy duty use, (ii) at least two and preferably three different types of attachments 100 including at least a socket wrench head 121, and a set of open end wrench heads 122 and/or a set of box end wrench heads 124, (iii) an adaptor 140, (iv) at least two and preferably three different types of bits 150 including a set of straight edge screwdriver bits 151 and a set of Philips screwdriver bits 152, and (v) a set of sockets 160.

In a second preferred embodiment, the compound tool is provided as a tool kit with at least (i) two handles 10, preferably at least three handles 10 each with a first portion of a first coupling system proximate the first longitudinal end 11 of the handle 10 and a second portion of the first coupling system proximate the second longitudinal end 12 of the handle 10, and (ii) at least one cooperating element selected from an attachment 100 and a combination of an adaptor 140 and a bit 150. A most preferred option of this second embodiment includes an attachment 100 with a socket wrench head 121 and longitudinally x extending mirror image shanks 110 and 210 with each shank 110, 210 having a first longitudinal end 111, 211 attached to the socket wrench head 121, and a second longitudinal end 112, 212 with a second portion of the first coupling system, such as a longitudinally x extending receiving cavity 118, 218, proximate the first longitudinal end 111, 211 of the shank 110, 210 respectively.

It is also generally preferred to configure the first coupling system so that the transversely extending post (unnumbered) on a socket wrench head 121 can cooperatively interact with the first coupling system on the handles 10, attachments 100 and adaptors 140. Such uniformity allows the various components to be interconnected in various combinations (e.g., the handles 10 may function as a standard handle when attached to the shank 110 of an attachment 100, an elongated lever when interconnected and then attached to the shank 110 of an attachment 100, or an extension when attached to the transverse post on a socket wrench head 121, and a socket 160 may be attached directly to a longitudinal end of a handle 10 for in-line use, or attached to the transverse post of a socket wrench head 121 which is attached to the handle 10 for cross-directional use).

Use

An attachment 100 or bit 150 is selected for use based upon the desired function. When an attachment 100 is selected, the attachment is simply attached to the handle 10 by inserting the post 40 into the receiving cavity 118 in the attachment 100 until the detent 50 “locks” into place within the dimple 118d. When the selected attachment 100 is a socket wrench head 121, a socket 160 is then selected and releasable attached to the post (unnumbered) as with typical socket wrenches.

When a bit 150 is selected, the adaptor 140 is first attached to the handle 10 by inserting the post 40 into the first receiving cavity 148 in the adaptor 140 until the detent 50 “locks” into place within the dimple 148d, and then the selected bit 150 is inserted into the second receiving cavity 149 in the adaptor 140.

Multiple handles 10 may be interconnected for creating a longer handle or lever by inserting the post 40 on one handle 10 into the receiving cavity 18 on another handle 10 until the detent 50 “locks” into place within the dimple 18d. A handle 10 may also be used as an extender by inserting the transverse post (unnumbered) on a socket wrench head 121 into the receiving cavity 18 at the first longitudinal end 11 of a handle 10 until the detent (unnumbered) “locks” into place within the dimple 18d and then attaching the desired attachment 100 or adaptor 140 to the post 40 at the second longitudinal end 12 of the handle 10.

I claim:

1. A compound tool comprising:
(a) a longitudinally elongated handle having a first longitudinal end, a second longitudinal end, and a first portion of a coupling system proximate the second longitudinal end of the handle, and
(b) at least two operably different attachments, each attachment having:
(1) a longitudinally extending shank with a first longitudinal end, a second longitudinal end, and a second portion of the coupling system proximate the first longitudinal end of the shank operative for releasably engaging the first portion of the coupling system whereby the handle and shank are longitudinally aligned when the first and second portions of the coupling system are engaged, and
(2) a head longitudinally extending from the second longitudinal end of the shank.

2. The compound tool of claim 1 further comprising at least two of the longitudinally extending handles with a second portion of the coupling system proximate the first longitudinal end of the handle whereby multiple handles form a longitudinally extended lever when the first portion of the coupling system on one handle engages the second portion of the coupling system on another handle.

3. The compound tool of claim 1 wherein the first portion of the coupling system is a post.

4. The compound tool of claim 3 wherein the post has four longitudinally extending parallel edges.

5. The compound tool of claim 3 wherein the tool further comprises a transversely projecting detent on the post.

6. The compound tool of claim 1 wherein the compound tool includes at least three attachments, each with operably different heads.

7. The compound tool of claim 1 wherein at least two of the attachments are selected from attachments with a socket wrench head, an open end wrench head, an adjustable end wrench head and a box end wrench head.

8. The compound tool of claim 1 wherein at least one of the attachments is an attachment with a socket wrench head and the compound tool further includes a set of sockets configured and arranged for opearable attachment to the socket wrench head.

9. The compound tool of claim 1 wherein the compound tool includes a set of attachments with either open end wrench heads or box end wrench heads.

10. A compound tool comprising:
(a) a longitudinally elongated handle having a first longitudinal end, a second longitudinal end, and a first portion of a first coupling system proximate the second longitudinal end of the handle,
(b) at least two operably different bits having a first longitudinal end, a second longitudinal end, an operable tip proximate the first longitudinal end of the bit, and a first portion of a second coupling system proximate the second longitudinal end of the bit, and
(c) an adaptor with a first longitudinal end, a second longitudinal end, a second portion of the first coupling system proximate the first longitudinal end of the adaptor operative for releasably engaging the first portion of the first coupling system whereby the handle and adaptor are longitudinally aligned when the first and second portions of the first coupling system are engaged, and a second portion of the second coupling system proximate the second longitudinal end of the adaptor operative for releasably engaging the first portion of the second coupling system whereby the adaptor and bit are longitudinally aligned when the first and second portions of the second coupling system are engaged.

11. The compound tool of claim 10 further comprising at least two of the longitudinally extending handles with a second portion of the first coupling system proximate the first longitudinal end of each handle whereby multiple handles form a longitudinally extended lever when the first portion of the first coupling system on one handle engages the second portion of the first coupling system on another handle.

12. The compound tool of claim 10 wherein the first portion of the first coupling system is a post.

13. The compound tool of claim 12 wherein the post has four longitudinally extending parallel edges.

14. The compound tool of claim 12 wherein the tool further comprises a transversely projecting detent on the post.

15. The compound tool of claim 10 wherein the compound tool includes at least three operably different bits.

16. The compound tool of claim 10 wherein at least two of the bits are selected from a straight edge screwdriver bit, a Philips screwdriver bit, a torx bit and an Allen wrench bit.

17. The compound tool of claim 10 wherein the compound tool includes at least one of a set of straight edge screwdriver bits and a set of Philips screwdriver bits.

18. A compound tool comprising:
(a) a plurality of longitudinally extending handles, each having a first longitudinal end, a second longitudinal end, a first portion of a first coupling system proximate the first longitudinal end of the handle, and a second portion of the first coupling system proximate the second longitudinal end of the handle operative for releasably engaging the first portion of the first coupling system whereby the handles form a longitudinally extended lever when the first portion of the first coupling system on one handle engages the second portion of the first coupling system on another handle, and
(b) at least one cooperating element comprising:
(1) an attachment having (−) a longitudinally extending shank with a first longitudinal end, a second longitudinal end, and a second portion of the first coupling system proximate the first longitudinal end operative for releasably engaging the first portion of the first coupling system whereby the handle and shank are longitudinally aligned when the first portion of the first coupling system on the handle and the second portion of the first coupling system on the shank are engaged, and (−) a head longitudinally extending from the second longitudinal end of the shank, or
(2) a combination of (−) a bit having a first longitudinal end, a second longitudinal end, an operable tip proximate the first longitudinal end of the bit, and a first portion of a second coupling system proximate the second longitudinal end of the bit, and (−) an adaptor with a first longitudinal end, a second longitudinal end, a second portion of the first coupling system proximate the first longitudinal end of the adaptor operative for releasably engaging the first portion of the first coupling system whereby the handle and adaptor are longitudinally aligned when the first portion of the first coupling system on the handle and the second portion of the first coupling system on the adaptor are engaged, and a second portion of the second coupling system proximate the second longitudinal end of the adaptor operative for releasably engaging the first portion of the second coupling system whereby the adaptor and bit are longitudinally aligned when the first and second portions of the second coupling system are engaged.

19. The compound tool of claim 18 wherein the at least one cooperating element includes at least an attachment having a socket wrench head with a first portion of the first coupling system extending transversely from the attachment.

20. The compound tool of claim 19 wherein the attachment includes mirror image longitudinally extending shanks with each shank having a first longitudinal end attached to the socket wrench head, a second longitudinal end, and a second portion of the first coupling system proximate the second longitudinal end of the shank.
